(19) United States
(12) Patent Application Publication
(10) Pub. No.: US 2024/0091642 A1
(43) Pub. Date: Mar. 21, 2024

(54) SYSTEMS FOR GENERATING UNIQUE NON-REPEATING SOUND STREAMS

(71) Applicant: SYNAPTICATS, INC., Portland, OR (US)

(72) Inventors: Erik ROGERS, Portland, OR (US); Mark ROGERS, Portland, OR (US)

(73) Assignee: SYNAPTICATS, INC., Portland, OR (US)

(21) Appl. No.: 18/514,804

(22) Filed: Nov. 20, 2023

Related U.S. Application Data
(63) Continuation of application No. 17/116,273, filed on Dec. 9, 2020, now Pat. No. 11,857,880.
(60) Provisional application No. 62/946,619, filed on Dec. 11, 2019.

(51) Int. Cl. A63F 13/54; G06F 3/16

(52) U.S. Cl. CPC A63F 13/54; G06F 3/165

(57) ABSTRACT

A method of mixing audio segments from audio clips to generate a unique stream of non-repeating sound, by: (a) inputting a plurality of audio source clips into an audio system; (b) applying a transfer function system to the plurality of audio source clips to select audio segments of the plurality of audio source clips, or applying a scheduling function system to the plurality of audio source clips to select playback times for the plurality of audio source clips; (c) applying a timeline renderer system to arrange the order of the selected audio segments; (d) applying a track renderer system to generate a plurality of audio playback clip tracks; (e) cross-fading the selected audio segments, thereby generating an audio playback having a unique sound stream; and (f) playing the audio playback having the unique sound stream.

### RELATED APPLICATIONS

This application is a Continuation of U.S. patent application Ser. No. 17/116,273, entitled Systems for Generating Unique Non-Looping Sound Streams from Audio Clips and Audio Tracks, filed Dec. 9, 2020, which claims priority to U.S. Provisional Patent Application Ser. No. 62/946,619, entitled Systems for Generating Unique Non-Looping Sound Streams From Audio Clips and Audio Tracks, filed Dec. 11, 2019, the entire disclosures of which are incorporated herein by reference in their entireties for all purposes.

### TECHNICAL FIELD

The present application is related to systems for generating unique non-repeating sound streams from audio segments in audio clips and to generating unique non-repeating audio tracks from the sound streams.

### BACKGROUND OF THE INVENTION

For relaxation and meditation, people often listen to recordings of ambient sounds. These recordings are typically of nature sounds such as sounds from a forest, a beach, a jungle, or a thunderstorm. A problem with listening to these recordings is that the listener becomes used to the order of the sounds (especially after playing the recordings over again and again). It would instead be desirable to avoid such repetition.

Another problem that too often occurs when making these recordings is that it is difficult to get a long recording without some unwanted sound, interruption or noise occurring at some point. Therefore, portions of the sound recordings are often unusable.

Another problem with sound recordings in the context of video games in particular is that a lengthy sound recording requires a considerable amount of memory storage. It would instead be desirable to avoid using such a large amount of memory for data storage.

What is instead desired is a system for generating an audio experience that does not rely on sounds that simply repeat over and over in the same order. Instead, a system for generating a unique stream of non-repeating sounds would be much more lifelike, and therefore much more desirable. In addition, it would be preferable to generate sound streams on the fly such that a sound stream could be generated at the same time that a user is listening to the sound stream. Moreover, it would be desirable to generate unique and non-repeating sound streams that can either be listened to immediately or stored as an audio file for export such that the sound stream could be listened to or processed at some future time. It would also be desirable that the system does not require excessive amounts of data storage. It would also be desirable to provide a system that can deal with the problem of unwanted sounds or noises in the recorded audio clips.

### SUMMARY OF THE INVENTION

The present audio system is capable of generating an infinite stream of non-repeating sounds. The stream generated by the present audio system is itself preferably composed of audio segments that are continuously arranged and re-arranged in different sequences for playback. These audio segments are cross-faded with one another to make the overall playback sound more seamless. Although the segments are chosen from the same finite source audio clips and therefore the sounds from the finite source audio clips will be repeated over time, the specific selections of segments is continually varied, presenting the sensation that the sounds are not repeating and are more natural. In addition, the segments need not correspond directly to the static source clips, but rather are preferably dynamically selected (sub-segments) from the source clips, thereby further increasing the variety and realism of the output audio. Moreover, the selected sound segments may have the same or different lengths, as desired. In addition, the cross-fades themselves may optionally have the same or different lengths.

As a result, a user listening (for example) to the sound of a forest will hear the sounds of birds, but the birdcalls will appear at different (e.g.: random or non-regularly repeating) times. Similarly, for the sound of a thunderstorm, the individual rolls of thunder can be made to occur at different times. As a result, the thunderstorm's behavior is not predictable to the user (in spite of the fact that all of the individual sounds that make up the thunderstorm audio track may have been listened to before by the user). To the listener, there is no discernible repeating sound pattern over time. Instead, a continuous stream of non-repeating sounds is generated.

In preferred aspects, the present system provides a method of generating a sound stream for playback, comprising:
(a) inputting a plurality of audio source clips into an audio processing system;
(b) selecting audio segments from within each of the plurality of audio source clips, wherein the audio segments that are selected have different starting times from one another;
(c) arranging the selected audio segments into a sequence;
(d) cross-fading the sequence of selected audio segments to form a sound stream; and then
(e) playing back the sound stream.

In preferred aspects, playing back the sound stream comprises playing back the sound stream live while the audio segments are being selected and cross-faded to form a continuous non-repeating sound stream for the listener. As such, live playback of the continuous non-repeating sound stream does not stop but continues indefinitely while the audio segments are continuously selected and cross-faded. In other preferred aspects, playing back the sound stream comprises storing the sound stream as an audio file for export and the sound stream can be transmitted to a remote computer, an audio player, a sound mixing board, a video game system, a home internet device such as an Apple® HomePod® or Google Nest®, smartphone, or other suitable device.

In various preferred aspects, the selected audio segments have different lengths from one another, and cross-fading the sequence of selected audio segments comprises performing cross-fades that have equal or unequal durations. The audio segments that are selected from the different audio source clips preferably have different starting times. When several audio segments are selected from within the same audio clip, these audio segments can be selected to have different starting times within the clip as well.

Once a plurality of different unique non-repeating sound streams have been generated by the present system, these different sound streams may be arranged into a sequence that is then cross-faded to form an audio track. Preferably, the sound streams that form the audio track can all have different starting times and different lengths.

In optional preferred aspects, some of the plurality of sound streams in the audio track are continuous and some of the plurality of sound streams in the audio track are discrete. For example, a unique non-repeating sound stream of a mountain stream can be continuous, and be played continuously, whereas an audio stream of a bird singing can be discrete and only be played at discrete intervals of time. Thus, a listener can hear the sound of a mountain stream with a bird visiting the area and singing from time to time. In optional preferred aspects, the user or listener has the option to suspend or vary the playback frequency of any of the plurality of sound streams in the audio track.

In further aspects, a plurality of different audio tracks can be arranged into a sequence and then cross-faded to form an audio experience. Different playback conditions can be selected for each of the audio tracks in the audio experience, and these playback conditions may correspond to game logic such that the game logic determines which of the audio tracks are played back and when.

The present invention also comprises a method of generating a sound stream for playback, comprising:
(a) inputting an audio source clip into an audio processing system;
(b) selecting audio segments from within the audio source clip, wherein the audio segments that are selected have different starting times from one another;
(c) arranging the selected audio segments into a sequence;
(d) cross-fading the sequence of selected audio segments to form a sound stream; and then
(e) playing back the sound stream.

In various aspects, playing back the sound stream comprises playing back the sound stream live while the audio segments are simultaneously being selected and cross faded to form a continuous non-repeating sound stream. In other aspects, playing back the sound stream comprises either: storing the sound stream as an audio file for export, or transmitting the sound stream to a remote computer, an audio player, a sound mixing board, a video game system, a home internet device such as an Apple® HomePod® or Google Nest®, smartphone, or other suitable device.

In yet further aspects, the present system provides a computer system for generating a sound stream for playback, comprising:
(a) a computer processing system for receiving a plurality of audio source clips;
(b) a computer processing system for selecting audio segments from within each of the plurality of audio source clips, wherein the audio segments that are selected have different starting times from one another;
(c) a computer processing system for arranging the selected audio segments into a sequence;
(d) a computer processing system for cross-fading the sequence of selected audio segments to form a sound stream; and
(e) a computer processing system for playing back the sound stream.

### BRIEF DESCRIPTION OF THE DRAWINGS

FIG. 1 is an illustration of a first arrangement of a sound sequence comprising a unique non-repeating sound stream generated by the present audio system using a source clip selection system and a timeline renderer system.

FIG. 2 is an illustration of a second arrangement of a sound sequence comprising a unique non-repeating audio track generated by the present audio system using a source stream scheduling system and an audio track rendering system.

FIG. 3 is an illustration of a third arrangement of a sound sequence comprising a unique non-repeating audio experience generated by the present audio system using a source track mixing system and a track mixing renderer system.

FIG. 4 is an illustration of audio segments taken from three different audio source clips, with the audio segments combined and cross-faded to generate a first unique and non-repeating audio stream.

FIG. 5 is an illustration of audio segments taken from four different audio source clips, with the audio segments combined and cross-faded to generate a second unique and non-repeating audio stream.

FIG. 6 is an illustration of five different audio segments cross-faded to form a unique and non-repeating audio stream.

FIG. 7 is an illustration of three different audio streams cross-faded to generate a unique and non-repeating audio track.

FIG. 8 is an illustration of a continuous audio stream and a discrete audio stream playing together as an audio track.

FIG. 9 is an illustration of three different audio tracks cross-faded to generate a unique and non-repeating audio experience.

FIG. 10 is an illustration of a computer architecture for performing the present invention.

### DETAILED DESCRIPTION OF THE DRAWINGS

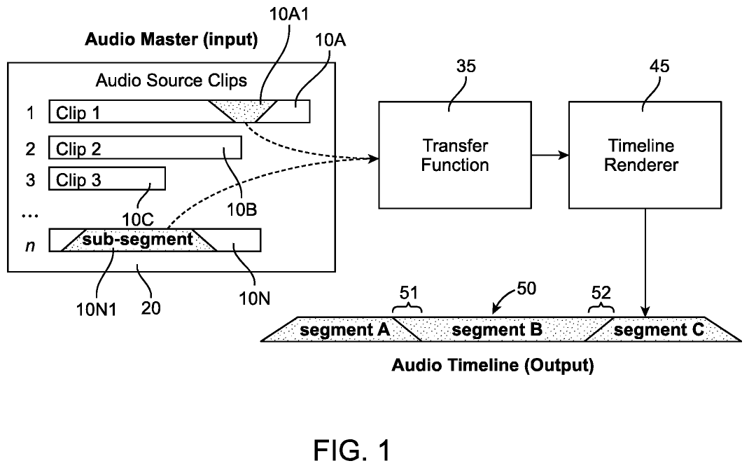

FIG. 1 is an illustration of a first arrangement of a sound sequence generated by the present audio system using a source clip selection system and a timeline renderer system, as follows:

A number of different audio source Clips 10A, 10B, 10C 10N are first inputted into an audio master system 20. Next, a Transfer Function 35 is applied to the plurality of audio source Clips 10A, 10B, 10C 10N to select audio Segments of the plurality of audio source Clips 10A, 10B, 10C 10N. For example, first Segment 10A₁ may be selected from audio source Clip 10A and a second Segment 10N₁ may be selected from audio source Clip 10N. Both of these selected Segments (10A₁ and 10N₁) can be operated on by Transfer Function 35.

Next, the Timeline Renderer system 45 applies a timeline rendering function to arrange the order of the selected audio Segments 10A₁, 10N₁, etc. At this time, the selected audio Segments are cross-faded as seen in Audio Timeline output Stream 50 such that the transition from one selected Segment to another (e.g.: segment A to segment B or segment B to segment C) is seamless and cannot be heard by the listener. The end result is that the present method of mixing audio segments from audio clips generates a unique stream of non-repeating sound Stream 50 which is then played back for the listener. (As illustrated, Segment A may correspond to audio source clip 10N₁, Segment B may correspond to audio source clip 10A₁, etc.)

As can be appreciated, from a finite set of audio Clips of finite length (i.e.: 10A, 10B, etc.), an infinite stream of non-repeating sound can be created (in audio timeline output Stream 50). Although individual sounds can appear multiple times in the output, there will be no discernible repeating pattern over time in audio timeline output Stream 50.

As can be seen, the individual sound Segments (10A1, 10N1, a.k.a. Segment A, Segment B, Segment C, etc.) are taken from selected audio Clips (10A to 10N), and specifically from selected locations within the audio Clips. In addition, the duration of the selected audio Clips is preferably also selected by Transfer Function 35. In various examples, the Transfer Function 35 selects audio segments of unequal lengths. In various examples, the Transfer Function system 35 randomly selects the audio Segments, and/or randomly selects the lengths of the audio Segments.

In optional embodiments, the Transfer Function 35 may use a weighted function to select the audio Segments. Alternatively, the Transfer Function 35 may use a heuristic function to select the audio Segments. In preferred aspects, the Transfer Function 35 chooses the segments to achieve a desired level of uniqueness and consistency in sound playback.

In optional embodiments, the duration of the cross-fades 51 and 52 between the audio Clips is unequal. The duration of the cross-fades 51 and 52 between the audio Clips can even be random.

In various preferred aspects, the audio source Clips are audio files or Internet URLs.

In preferred aspects, the Transfer Function system 35 continues to select audio Segments and the Timeline Renderer 45 continues to arrange the order of the selected audio Segments as the audio playback Clip is played. Stated another way, a unique audio Stream 50 can be continuously generated at the same time that it is played back for the listener. As a result, the unique audio Stream 50 need not “end”. Rather, new audio Segments can be continuously added in new combinations to the playback sequence audio Stream 50 while the user listens. As such, the playback length can be infinite.

The present system has specific benefits in relaxation and meditation since the human brain is very adept at recognizing repeating sound patterns. When a static audio loop is played repetitiously, it becomes familiar and is recognized by the conscious mind. This disrupts relaxing, meditation or even playing a game. In contrast, the audio of the present system can be play endlessly without repeating patterns which allows the mind to relax and become immersed in the sound.

Therefore, an advantage of the present system is that these large sound experiences can be produced from a much smaller number of audio clips and segments, thereby saving huge amounts of data storage space. With existing systems, very long sequences of audio must be captured without interruption. In contrast, with the present system, multiple, shorter audio clips can be used instead as input. This makes it much easier to capture sounds under non-ideal conditions.

Since the present audio playback stream is formed from endless combinations of shorter audio Segments played over randomly or in various sequences, the present unique audio Stream will have a length greater than the duration of the audio source Clips. In fact, the present unique audio playback stream may well have infinite length.

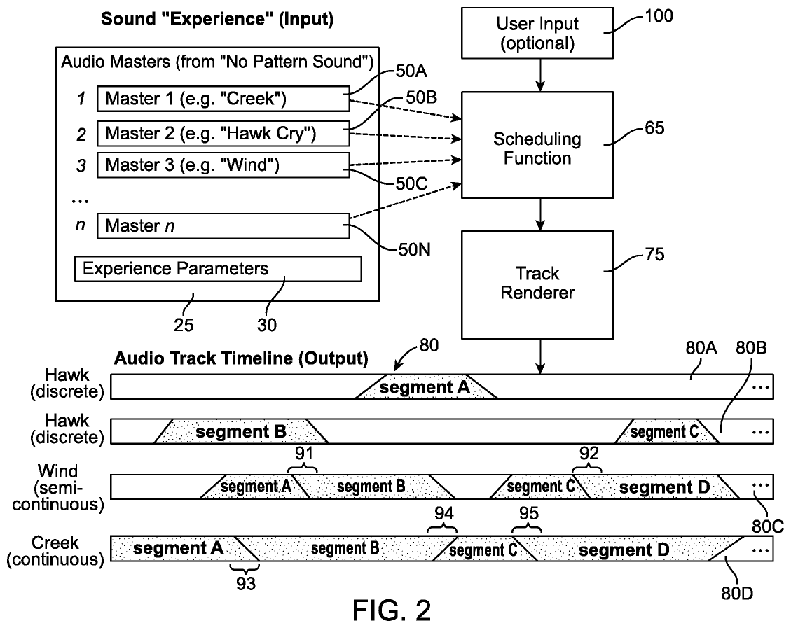

FIG. 2 is an illustration of a second arrangement of a sound sequence generated by the present audio system using a source clip Scheduling System 65 and an audio Track Rendering system 75. In this embodiment, a plurality of audio master Streams 50A, 50B, 50C . . . 50N, is again inputted into a sound experience system 25 (i.e.: “sound experience (input)”). Next, a Scheduling Function 65 is applied to the plurality of audio master Streams to select playback times for the plurality of audio master Streams 50A, 50B, 50C . . . 50N. Next, a Track Renderer 75 is applied to generate a plurality of audio playback Tracks 80A, 80B, 80C, 80D, etc. Together, Tracks 80A to 80N contain various combinations of scheduled discrete, semi-continuous, and continuous sounds that make up a “sonic Experience” such as forest sounds (in this example two hawks, wind that comes and goes, and a continuously flowing creek). As such, audio master Streams 50A to 50N are scheduled into a more layered experience of multiple sounds that occur over time, sometimes discretely (hawk cry) or continuously (creek), or a combination of both (wind that comes and goes). Scheduling Function system 65 and Track Renderer 75 selectively fade Tracks 80A to 80N in and out at different times. Accordingly, the listener hears a unique sound Track 80. In addition, experience parameters 30 determine various aspects of the scheduled output, including how many Tracks 80A, 80B, etc. are outputted. In addition, experience parameters 30 determine how often discrete sounds are scheduled to play (for example, how often the Hawks cry from the example in FIG. 2, Tracks 80A and 80B), the relative volume of each sound, and other aspects. The Experience Parameter system 25 determine how often discrete Tracks play, how often semi-discrete Tracks fade out and for how long they are faded out and for how long they play.

In many ways, the system of FIG. 2 builds upon the previously discussed system of FIG. 1. For example, the sound Segments (variously labelled A, B, C, D) that make up the individual tracks 80A, 80B, 80C and 80D are composed of the selections made by the Transfer Function 35 and Timeline Renderer 45 from the system of FIG. 1.

Optionally, in the aspect of the invention illustrated in FIG. 2, a user input system 100 can also be included. The user input system 100 controls the Scheduling Function system 65 such that a user can vary or modify the selection frequency of any of the audio master Streams 50A, 50B . . . 50N. For example, master audio Stream 50B can be a “Hawk Cry”. Should the listener not wish to hear the sound of a hawk cry during the sound playback, the user can use the input control system to simply turn off or suspend the sound of Stream 50B of the hawk cry (or make it occur less frequently), as desired. In this example, the user's control over the sound selection frequency forms part of the user's experience. The user is, in essence, building their own sound scape or listening environment. The very act of the user controlling the sounds can itself form part of a meditative or relaxation technique. As such, the user input system 100 optionally modifies or overrides the experience parameters system 30 that govern Scheduling Function 65 and Track Renderer 75. In various preferred aspects, the user input system may include systems that monitor or respond to the users biometrics such as heart rate, blood pressure, breathing rate and patterns, temperature, brain wave data, etc.

As illustrated in FIG. 2, the listener hears an audio Track 80 that combines two Hawks (80A and 80B), the Wind (80C) and the sound of a Creek (80A). As can be seen, the sound of the Creek is continuous in audio track 80D (with cross-fades 93, 94 and 95) between its various shorter sound segments A, B, C and D. The sound of the Wind (audio Track 80C) is semi-continuous (as it would be in nature). The sounds of the hawk(s) (audio Tracks 80A and 80B) are much more intermittent or discreet and may be sound segments that are faded in and out. In the semi-continuous or continuous mode, each potentially infinite audio master clip preferably plays continuously or semi-continuously.

In optional aspects, the Scheduling Function 65 randomly or heuristically selects playback times for the plurality of audio master Streams 50A, 50B . . . etc. The tracks are assembled in time to produce the unique audio Track 80.

Similar to the system in FIG. 1, the Scheduling Function system 65 continues to select playback times for the plurality of audio master Streams 50A, 50B . . . 50N and the Track Renderer 75 continues to generate a plurality of audio playback Tracks (80A, 80B, 80C and 80D) as the audio playback Track 80 is played. As such, the audio playback Track 80 has the unique audio stream that may be of infinite length.

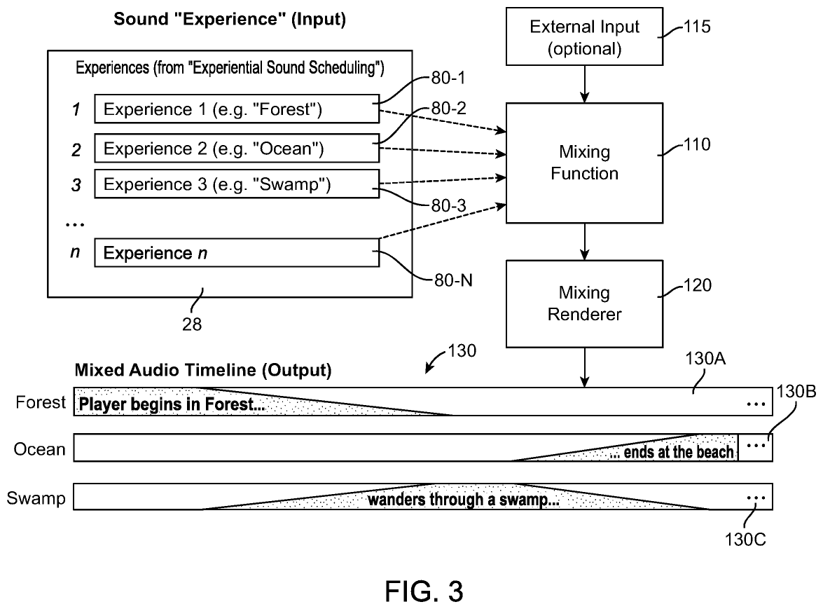

FIG. 3 is a third embodiment of the present system, as follows:

In this embodiment, a plurality of audio playback Tracks 80-1, 80-2, 80-3 . . . 80-N are inputted into an Audio Experiences system 28 (i.e.: “sound experiences (input)”). Next, a Track Mixing Function 110 is applied to the plurality of audio Tracks 80-1, 80-2, 80-3 . . . 80-N to select playback conditions for the plurality of audio Tracks. A Track Mixing Renderer 120 is then applied to generate an audio playback Experience 130 corresponding to the selected playback conditions.

Similar to the systems in FIGS. 1 and 2, the selected audio Tracks 80-1, 80-2, and 80-3 (up to 80-N) can be cross-faded. The final result is a unique audio playback experience 130 that corresponds to the selected playback conditions which is then played back. A plurality of Tracks 80-1 to 80-N are used as the input to the Mixing Function 110 and Mixing Renderer 120 to create an audio Experience 130 that has an “atmospheric ambience” that changes randomly, heuristically, or by optional External Input control system 115.

In the example of FIG. 3, the External Input 115 comes from the actions in a video game where the player is wandering through a Forest Experience, then into a Swamp Experience, and finally ends up at the Beach Experience. Specifically, when the player is initially in a forest, they will hear forest sounds. As the player moves out of the forest and through a swamp, they will hear less forest sounds and more swamp sounds. Finally, as the player leaves the swamp and emerges at a beach, the swamp sounds fade away and the sounds of the waves and wind at the beach become louder. (This is seen in FIG. 3 as the Forest Experience 130A starts and then is faded out as the Swamp Experience 130C is faded in. Next, the Swamp Experience 130C is faded out and the Beach Experience 130B is faded in). In this example, the atmospheric ambience changes as the user wanders, matching the user's location within the game world and seamlessly blending between the experiences as the user wanders. In this example, the audio playback corresponds to the position of the game player in the virtual world. The optional External Input 115 could just as easily be driven by the time of day, the user's own heartbeat, or other metrics that change the ambience in a way that is intended to induce an atmosphere, feeling, relaxation, excitement, etc. It is to be understood that the input into External Input 115 is not limited to a game.

The present system can also be used to prepare and export foley tracks for use in games and films and the present system logic may also be incorporated into games and other software packages to generate unique sound atmospheres, or that respond to live dynamic input creating ambient effects that correspond to real or simulated events, or that create entirely artistic renditions.

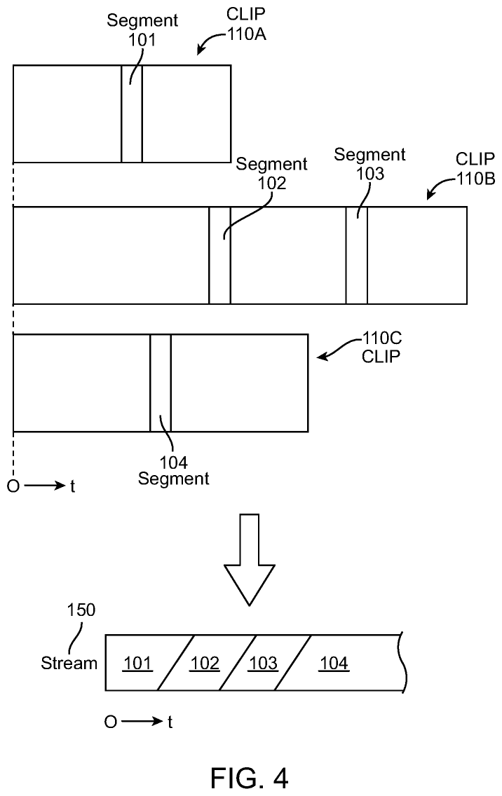

FIG. 4 is an illustration of audio Segments taken from three different audio source Clips, with the audio Segments combined by being put into a sequence and then cross-faded to generate a unique and non-repeating audio Stream 150. Specifically, audio source Clips 110A, 110B and 110C are three separate recordings. These audio Clips can be of different durations (as illustrated by their different lengths on the time axis). In preferred aspects, the durations of the recordings that make up each of Clips 110A, 110B and 110C can be on the order of a few seconds to many minutes long. The present invention is understood to encompass audio source Clips (i.e.: recordings) of any length.

In accordance with the present system, specific Segments of these Audio Clips 110A, 110B and 110C are combined to provide a unique and non-repeating sound Stream, as follows. Various audio Segments are taken from each of these Clips. Specifically, in the illustrated example, Segment 101 is taken from Clip 110A. Next, Segments 102 and 103 are both taken from Clip 110B and finally Segment 104 is taken from Clip 110C. (It is to be understood that different Segments can be taken from these different Clips, and that different Segments can be taken from different Clips in any order). As can be seen in the example of FIG. 4, Segments 101, 102, 103, 104, etc. can have different start times (as indicated by different positions on their respective time axes) and the various audio Clips 101, 102, 103, 104, etc. can all have unequal durations (as indicated by their different lengths on their respective time axes). As can also be seen, two audio Segments can be taken from the same Clip (e.g.: Segments 102 and 103 are both taken from Clip 110B). Moreover, in optional embodiments, all of the various Segments can be taken from the same Clip and then combined endlessly to generate a unique and non-repeating sound Stream. This has the advantage of only requiring one recording to generate an endless, non-repeating sound stream for a listener to listen to and enjoy.

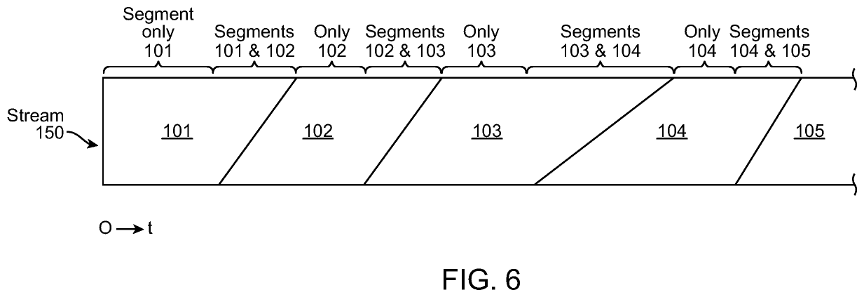

A unique audio Stream 150 is then generated by arranging and playing Segments 101, 102, 103, 104, etc. one after another. As can also be seen, and as will be fully explained in FIG. 6, the Segments 101, 102, 103, 104, etc. are then cross-faded with one another to provide seamless listening for the user. As can be appreciated from the illustration, a more vertical sloped line in FIGS. 4 (and 5) illustrates a faster cross-fade from one Segment to the next whereas a more horizontal sloped line illustrates a cross-fade between Segments that takes place over a longer period of time.

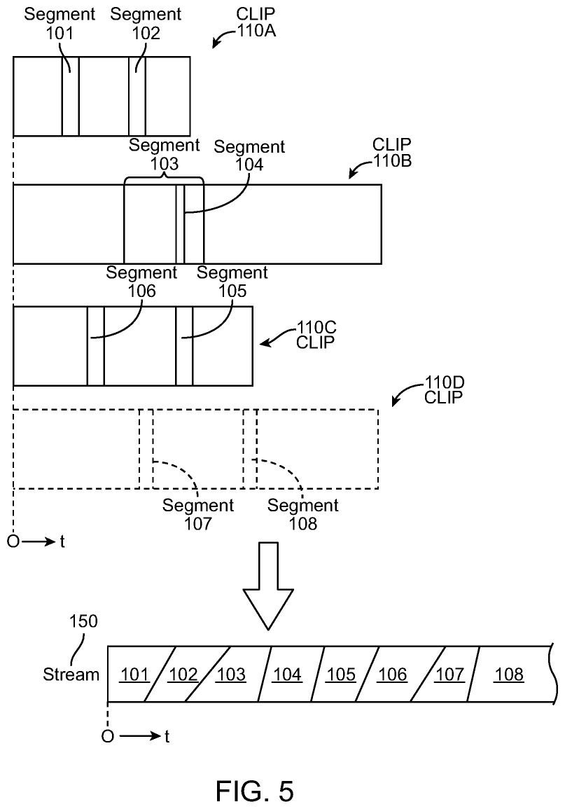

FIG. 5 is an illustration of audio Segments taken from four different audio source Clips (i.e.: recordings), combined and cross-faded to generate a second unique and non-repeating audio Stream 150. In this example, initially the system has only received recorded Clips 110A, 110B and 110C when it begins operation. The operation of the example of FIG. 5 is very similar to that of FIG. 4 in many respects. In FIG. 5, Segments 101 and 102 are taken from Clip 110A at different time periods within the recorded Clip. Segments 103 and 104 are both taken from Clip 110B. As can be seen, Segment 103 is considerably longer in time duration than Segment 104 and Segment 103 starts at a time before Segment 104 and ends after Segment 104 ends. Segments 105 and 106 are both taken from Clip 110C, with Segment 106 taken from an earlier period of time in the Clip than Segment 105. The present system arranges Segments 101 to 106 in a sequence and then cross-fades these Segments together to generate a unique sound Stream 150. While the listener is listening to the playback of sound Stream 150, a new audio Clip 110D (shown in dotted lines) is inputted into the system and two new Segments 107 and 108 are added to the Sound Stream 150 as the sound Stream is being played. This illustrates the fact that additional Clips and Segments from these Clips (and previously added Clips) can be added to the sound Stream 150 as the sound Stream is played back. The result is a continuous and non-repeating sound Stream 150 generated on the fly in real time for a listener.

It is to be understood that the present invention encompasses adding audio Segments of any duration, with the Segments starting at any start time, and in any order. Moreover, the cross-fades between Segments can be the same or different lengths. In preferred aspects, the sound Stream 150 (as in FIG. 4 or 5) can be generated while a listener is playing back or listening to the sound Stream. As such, the present invention can generate a unique sound Stream 150 of infinite length since new Segments (of different durations and start times) can continuously be selected from any one of the audio source Clips and added to the sound Stream as it is played.

FIG. 6 is a more detailed illustration of how five different audio Segments 101, 102, 103, 104 and 105 can all be cross-faded to form a unique and non-repeating audio Stream 150. Stream 150 plays each of Segments 101, 102, 103, 104 and 105 one after another (from left to right on the page, following the time axis “t”). As can be seen, the cross-fading is illustrated by the sloped lines between the successive audio Segments 101 to 105. Specifically, at a first period of time, only Segment 101 is playing. Next, Segment 101 is faded out and Segment 102 is faded in (at this time both of Segments 101 and 102 can be heard). Next, Segment 102 is played alone until Segment 103 starts to fade in and Segment 102 is faded out. As can be appreciated from the illustration, a more vertical sloped line in FIG. 6 illustrates a faster cross-fade from one Segment to the next whereas a more horizontal sloped line illustrates a cross-fade between Segments that takes place over a longer period of time.

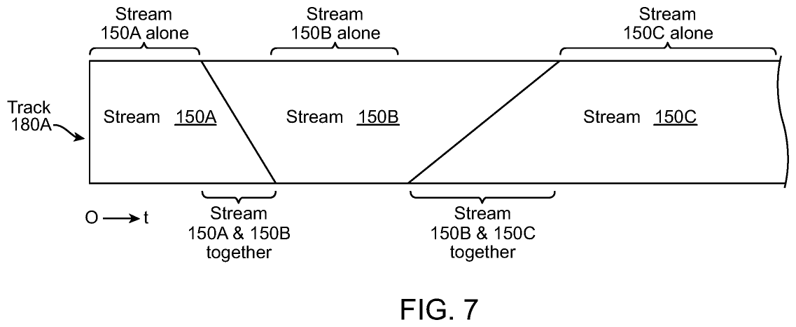

FIG. 7 is an illustration of three different audio Streams 150A, 150B and 150C cross-faded to generate a first unique and non-repeating audio Track 180A. This is carried out similar to the manner in which audio Segments (101, 102, etc.) where cross faded to generate a unique and non-repeating audio Stream 150 (in FIGS. 4 to 6). As can be seen in FIG. 7, Stream 150A is initially played and then is faded out as Stream 150B is faded in and played. Next, Stream 150B is faded out and Stream 150C is faded in and played for the listener, etc. This is particularly useful when each of Streams in the Track represent, for example, sounds such as a light rain (Stream 150A), a heavier rain (Stream 150B) and a thunderstorm (Stream 150C). In accordance with the present system, sequentially playing Streams 150A, then 150B then 150C would simulate the arrival of a thunderstorm over time.

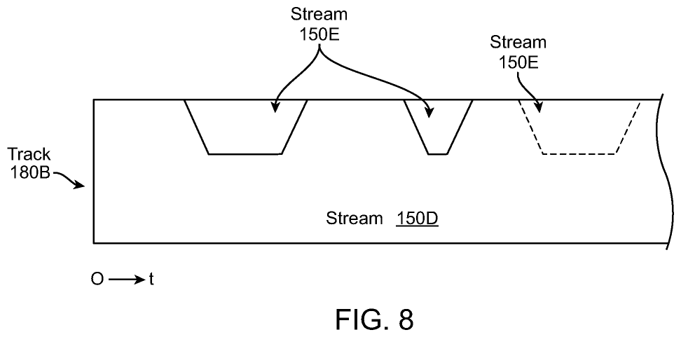

FIG. 8 is an illustration of a continuous audio Stream 150D and a discrete audio Stream 150E playing together as an audio Track 180B. In this example, Stream 150D may be the sound of a mountain stream and Stream 150E may be the sound of a bird singing. As such, Stream 150D is continuously played while Stream 150E is only played intermittently (i.e.: at discrete intervals of time). In accordance with the present invention, the user/listener may also be able to turn on or off the discretely played Stream 150E (with the third interval of Stream 150E in FIG. 8 illustrated in dotted lines as an optional sound).

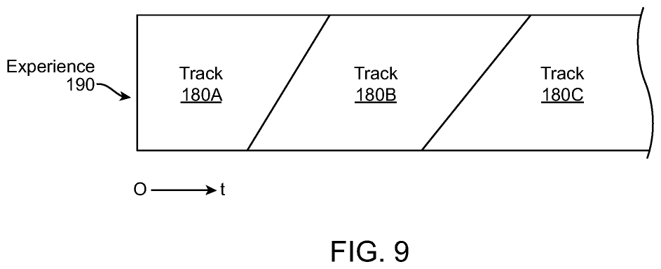

FIG. 9 is an illustration of three different audio Tracks 180A, 180B and 180C being arranged and cross-faded to generate a unique and non-repeating audio Experience 190. This is done similar to the manner in which audio Streams 150 were arranged and cross-faded to form audio Tracks 180 in FIGS. 7 and 8.

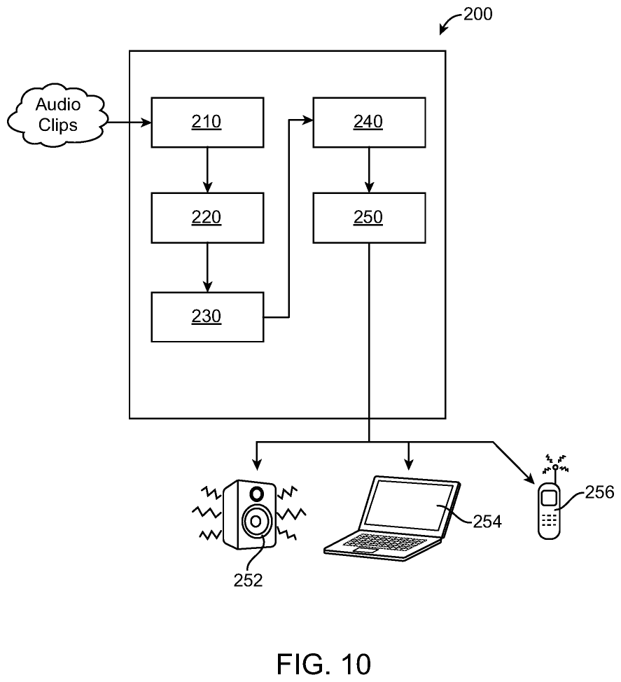

Lastly, FIG. 10 is an illustration of a computer architecture for performing the present invention. Computer architecture 200 specifically includes a computer system 200 for generating a sound stream for playback, comprising:
(a) a computer processing system 210 for receiving a plurality of audio source Clips 110A, 110B, 110C, etc.;
(b) a computer processing system 220 for selecting audio Segments 101, 102, 103, 104, etc. from within each of the plurality of audio source Clips 110, wherein the audio Segments 101, 102, 103, 104, etc. that are selected have different starting times from one another;
(c) a computer processing system 230 for arranging the selected audio Segments 101, 102, 103, 104, etc. into a sequence;
(d) a computer processing system 240 for cross fading the sequence of selected audio Segments 101, 102, 103, 104, etc. to form a sound Stream 150; and
(e) a computer processing system 250 for playing back the sound Stream 150.

In preferred aspects, the computer processing system 250 for playing back the sound stream comprises: (i) a playback system 252 (such as a speaker) for playing the sound stream live as the audio Segments and Tracks are simultaneously selected and cross-faded, (ii) a playback system 254 for storing the sound stream as an audio file for export or transmission to a remote computer, (iii) a smartphone 256, or (iv) other suitable device including an audio player, a sound mixing board, a video game system, a home internet device such as an Apple® HomePod® or Google Nest®, etc. It is also to be understood that the present system may be coded or built into software that is resident in any of these devices.

What is claimed is:

1. A method of generating a sound stream for playback, comprising:
(a) inputting a plurality of audio source clips into an audio processing system;
(b) selecting audio segments from within each of the plurality of audio source clips, wherein the audio segments that are selected have different starting times from one another;
(c) arranging the selected audio segments into a sequence;
(d) cross-fading the sequence of selected audio segments to form a sound stream; and then
(e) playing back the sound stream.

2. The method of claim 1, wherein playing back the sound stream comprises playing back the sound stream live while the audio segments are being selected and cross-faded to form a continuous non-repeating sound stream.

3. The method of claim 2, wherein live playback of the continuous non-repeating sound stream does not stop but continues indefinitely while the audio segments are continuously selected and cross-faded.

4. The method of claim 1, wherein playing back the sound stream comprises storing the sound stream as an audio file for export.

5. The method of claim 1, wherein playing back the sound stream comprises transmission of the sound stream to a remote computer.

6. The method of claim 1, wherein the selected audio segments have different lengths from one another.

7. The method of claim 1, wherein cross-fading the sequence of selected audio segments comprises performing cross-fades that have unequal durations.

8. The method of claim 1, wherein the audio segments that are selected from different audio source clips have different starting times.

9. The method of claim 1, wherein the audio segments that are selected from within the same audio source clip have different starting times.

10. The method of claim 1, further comprising:
arranging a plurality of sound streams into a sequence; and
cross-fading the sequence of sound streams to form an audio track.

11. The method of claim 10, wherein each of the sound streams have different starting times and different lengths.

12. The method of claim 10, wherein some of the plurality of sound streams in the audio track are continuous and some of the plurality of sound streams in the audio track are discrete.

13. The method of claim 10, wherein a user plays back the audio track while suspending playback or varying a playback frequency of any of the plurality of sound streams in the audio track.

14. The method of claim 10, further comprising:
arranging a plurality of audio tracks into a sequence; and
cross-fading the sequence of audio tracks to form an audio experience.

15. The method of claim 14, further comprising selecting playback conditions for each of the audio tracks in the audio experience.

16. The method of claim 15, wherein the playback conditions correspond to game logic such that the game logic determines which of the audio tracks are played back.

17. A method of generating a sound stream for playback, comprising:
(a) inputting an audio source clip into an audio processing system;
(b) selecting audio segments from within the audio source clip, wherein the audio segments that are selected have different starting times from one another;
(c) arranging the selected audio segments into a sequence;
(d) cross-fading the sequence of selected audio segments to form a sound stream; and then
(e) playing back the sound stream.

18. The method of claim 17, wherein playing back the sound stream comprises playing back the sound stream live while the audio segments are being selected and cross faded to form a continuous non-repeating sound stream.

19. The method of claim 17, wherein playing back the sound stream comprises either:
storing the sound stream as an audio file for export, or
transmitting the sound stream to a remote computer.

20. The method of claim 17, wherein the selected audio segments have different lengths from one another.

21. The method of claim 17, wherein cross fading the sequence of selected audio segments comprises performing cross-fades that have unequal durations.

22. A computer system for generating a sound stream for playback, comprising:
(a) a computer processing system for receiving a plurality of audio source clips;
(b) a computer processing system for selecting audio segments from within each of the plurality of audio source clips, wherein the audio segments that are selected have different starting times from one another;
(c) a computer processing system for arranging the selected audio segments into a sequence;
(d) a computer processing system for cross-fading the sequence of selected audio segments to form a sound stream; and
(e) a computer processing system for playing back the sound stream.

23. The device of claim 22, wherein the computer processing system for playing back the sound stream comprises:
(i) a playback system for playing the sound stream live as the audio segments are simultaneously selected and cross-faded, or
(ii) a playback system for storing the sound stream as an audio file for export or transmission.

24. A computer system for generating a sound stream for playback, comprising:
(a) a computer processing system for an audio source clip;
(b) a computer processing system for selecting audio segments from the audio source clip, wherein the audio segments that are selected have different starting times from one another;
(c) a computer processing system for arranging the selected audio segments into a sequence;
(d) a computer processing system for cross-fading the sequence of selected audio segments to form a sound stream; and
(e) a computer processing system for playing back the sound stream.
